(19) United States
(12) Patent Application Publication
(10) Pub. No.: US 2025/0322256 A1
(43) Pub. Date: Oct. 16, 2025

(54) REDUCED PRECISION NEURAL FEDERATED LEARNING

(71) Applicant: Arm Limited, Cambridge (GB)

(72) Inventors: Chuteng Zhou, Somerville, MA (US); Durmus Alp Emre Acar, Saugus, MA (US); Bokun Wang, College Station, TX (US)

(21) Appl. No.: 18/633,324

(22) Filed: Apr. 11, 2024

(51) Int. Cl. G06N 3/098; G06N 3/0495

(52) U.S. Cl. CPC G06N 3/098; G06N 3/0495

(57) ABSTRACT

An end user device receives a neural network model comprising one or more weights in a reduced-precision format. The received neural network model weights are converted from the reduced-precision format to a high-precision format in the device. The high-precision neural network model is trained using an iterative process by training the neural network in a reduced-precision format compute unit in the device and updating the converted high-precision format neural network model based on the training. The trained high-precision format neural network model is converted to the reduced-precision format to produce a trained reduced-precision format neural network model, and the trained reduced-precision format neural network model is sent to the remote server for aggregation with other trained reduced-precision format neural network models from other end user devices to generate an updated trained high-precision neural network model.

### FIELD

The field relates generally to neural network training, and more specifically to reduced precision neural federated learning.

### BACKGROUND

Computers are valuable tools in large part for their ability to communicate with other computer systems and retrieve information over computer networks. Networks typically comprise an interconnected group of computers, linked by wire, fiber optic, radio, or other data transmission means, to provide the computers with the ability to transfer information from computer to computer. The Internet is perhaps the best-known computer network, and enables millions of people to access millions of other computers such as by viewing web pages, sending e-mail, or by performing other computer-to-computer communication.

Modern computerized devices such as smartphones perform many of the functions that were primarily performed by large desktop computers a generation ago, such as web browsing, text messaging, emailing, videoconferencing, and playing video games. Such devices increasingly employ advanced technologies employing artificial intelligence, such as voice assistants, AI-enhanced graphics, and the like. Apple Siri and Google Assistant are examples of voice assistants that employ artificial intelligence such as neural networks, pretrained generative transformers, and the like to enable natural language communication and provide answers to natural language questions.

The way that end users use or interact with such artificial intelligence tools on end user devices may be used to further improve or train artificial intelligence tools using a process called federated learning. To employ federated learning, data on end user devices may be used on the end user devices to train local copies of a neural network or other artificial intelligence tool, which are subsequently integrated or combined together in a central server to form a composite trained AI tool.

Training using federated learning is desirably performed in a way that preserves the privacy and security of the end user's training information, including Personally Identifiable Information (PII) and user profile or behavioral information, and is a challenge for both individual users and for companies that collect user information such as this. Personally Identifiable Information includes not only information such as name, birthdate, social security number, and the like, but also includes information such as a user's biometric or behavioral information, the user's text messages and emails, and the user's interactions with others. This information could be used to impersonate a user or steal their identity, to target advertising or other goods and services to a user, or to gather information about a user that they might otherwise wish to remain private.

Rules such as Europe's General Data Protection Regulation (GDPR) have placed limits on what companies can legally do with personal information collected from networked computer users, and what can be done with such information, what types of information can be collected, and similar restrictions. Even when a user consents to their personal information being collected, such as behavioral information collected to help improve development of a product, collected data is typically only allowed to be used for a narrowly defined purpose and for a minimum period of time needed to complete the task. The repository of collected user information is further often a target for malicious activity such as theft of personal information, and presents additional challenges and responsibilities for the data collector.

Many users do not wish to share their personal information with others, desiring instead to maintain their privacy when interacting with various services such as web pages, smart phone apps, and the like. But, service providers such as voice assistant tool providers and other artificial intelligence tool providers use such personal information to improve the relevance and performance of their artificial intelligence tools. Federated learning serves to preserve personal information by training a local version of an artificial intelligence tool, returning only the tool model with updated training to a remote server for aggregation with other such trained models. The user's privacy may be preserved because the user's personal data never leaves their device, but the size of artificial intelligence models such as neural networks or generative pretrained transformers may be quite large, consuming significant network bandwidth to upload and download, using significant processing resources and battery life to train, and taking significant storage on the end user device.

For reasons such as these, a need exists for improved management of federated learning of artificial intelligence models on end user devices.

### BRIEF DESCRIPTION OF THE DRAWINGS

The claims provided in this application are not limited by the examples provided in the specification or drawings, but their organization and/or method of operation, together with features, and/or advantages may be best understood by reference to the examples provided in the following detailed description and in the drawings, in which:

FIG. 1 is a block diagram of a computing environment that may be used to practice reduced-precision federated learning, consistent with an example embodiment.

FIG. 2 is a diagram showing example reduced-precision number formats, consistent with an example embodiment.

FIG. 3 is a block diagram showing high-precision and reduced-precision machine learning models in a federated learning environment, consistent with an example embodiment.

FIG. 4 shows two methods of converting a number from one quantization format to another, consistent with an example embodiment.

FIG. 5 shows charts illustrating the reduction in for various levels of machine learning model accuracy, consistent with an example embodiment.

FIG. 6 is a flow diagram of a method of employing federated learning in end user devices using reduced-precision machine learning models, consistent with an example embodiment.

FIG. 7 is a schematic diagram of a neural network, consistent with an example embodiment.

FIG. 8 shows a block diagram of a general-purpose computerized system, consistent with an example embodiment.

Reference is made in the following detailed description to accompanying drawings, which form a part hereof, wherein like numerals may designate like parts throughout that are corresponding and/or analogous. The figures have not necessarily been drawn to scale, such as for simplicity and/or clarity of illustration. For example, dimensions of some aspects may be exaggerated relative to others. Other embodiments may be utilized, and structural and/or other changes may be made without departing from what is claimed. Directions and/or references, for example, such as up, down, top, bottom, and so on, may be used to facilitate discussion of drawings and are not intended to restrict application of claimed subject matter. The following detailed description therefore does not limit the claimed subject matter and/or equivalents.

### DETAILED DESCRIPTION

In the following detailed description of example embodiments, reference is made to specific example embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made.

Features or limitations of various embodiments described herein, however important to the example embodiments in which they are incorporated, do not limit other embodiments, and any reference to the elements, operation, and application of the examples serve only to aid in understanding these example embodiments. Features or elements shown in various examples described herein can be combined in ways other than shown in the examples, and any such combinations is explicitly contemplated to be within the scope of the examples presented here. The following detailed description does not, therefore, limit the scope of what is claimed.

As end user devices such as smartphones continue to grow in features and processing power, new applications such as artificial intelligence are being employed for applications such as voice assistants, text completion, malware detection, graphics processing, and other such applications. These devices typically serve a wide variety of users, and may experience different queries, text strings, graphics processing tasks, and the like due to the different content and interactions that various users have with such artificial intelligence tools. It may therefore be desirable to train the artificial intelligence models, such as neural networks or generative pretrained transformers, with the actual content observed in end user devices. This process may be referred to as “federated learning,” and may both capture a much wider variety of real-world training data than other methods and distribute the training task among many end user devices rather than performing such training tasks in a centralized server.

Federated learning has the additional advantage of leaving end user content on the end user's devices, preserving the privacy of the end users. Protecting Personally Identifiable Information or PII in particular is legally required to various degrees in some jurisdictions, such as the European Union where the General Data Protection Regulation (GDPR) places limits on collection and use of such information. User data such as name, birthdate, social security number, and the like can be used to impersonate a person or steal their identity, and more private information such as medical history, financial status, or the like may be embarrassing for the user to have made public or have other reasons the user desires information privacy.

Similarly, a user's generated content and communication such as emails, text messages, and photos can reveal a great deal about a person, including personal or private information they don't wish to share with anyone other than the intended recipient. Other information such as biometric or behavioral information such as a user's fingerprint or what activities a user performs when online are also desirably kept secret, as they often relate to security of the user's other accounts or to private activity the user does not wish to share with others. But, protecting personal information is made more complicated because such information is also often used for legitimate purposes, such as where a user's legitimate communications such as emails or text messages can be used to train a machine learning tool to better serve the user, such as to translate the user's voice to text or to differentiate between malicious and benign content.

Some regulations have placed limits on what companies can do with personal information collected from computer users and what can be done with such information, but these regulations vary significantly between jurisdictions and are rapidly changing. Some companies seek a user's consent (such as by disclosure or click-through acceptance) as to what types of information may be collected, how it may be used, and how long it may be retained, and some jurisdictions have their own restrictions stating that collected data is only allowed to be used for a narrowly defined purpose and for a minimum period of time needed to complete the task. Repositories of collected user information are further often a target for malicious activity such as theft of personal information, and present additional challenges and responsibilities for the data collector.

Federated learning of artificial intelligence or machine learning models addresses user data privacy concerns such as these by leaving end user data on the user's device, but may often involve a somewhat resource-intensive process of communicating a large machine learning model to the end user device, storing the machine learning model in storage such as flash memory on the user device, consuming significant user device resources such as computational power and battery power to train the stored machine learning model, and sending the trained or updated machine learning model back to a central server for combination or aggregation with other federated learning machine learning models to generate a new or global updated machine learning model.

Some examples presented herein may therefore seek to reduce the communications, storage, training computation, and/or other such burdens on the end user devices in a federated learning environment involving machine learning models by using a reduced-precision format for one or more tensors in the machine learning model. In one such example, an end user device receives a neural network model from another device such as a remote server, the neural network model comprising one or more weights received in a reduced-precision format. The received neural network model weights are converted from the reduced-precision format to a high-precision format in the device. The high-precision neural network model is trained using an iterative process by training the neural network in a reduced-precision format compute unit in the device and updating the converted high-precision format neural network model based on the training. The trained high-precision format neural network model is converted to the reduced-precision format to produce a trained reduced-precision format neural network model, and the trained reduced-precision format neural network model is sent to an aggregating system such as a remote server for aggregation with other trained reduced-precision format neural network models from other end user devices to generate an updated trained high-precision neural network model.

In a more detailed example, conversion between the reduced-precision format and the high-precision format may be designed to improve or preserve detail embedded in the reduced-precision format weights. In one such example, updating the reduced-precision format weights based on the updated converted high-precision format neural network model in the example above may be achieved by rounding the converted high-precision format neural network weights to reduced-precision format weights using nearest neighbor rounding. In another example, converting the trained high-precision format neural network model to the reduced-precision format comprises rounding the trained high-precision format neural network weights to reduced-precision format weights using unbiased stochastic quantization.

In an example where the high-precision weights comprise FP32 or 32-bit floating point numbers, the reduced-precision format may comprise FP8 or 8-bit floating point numbers. The FP8 format in a more detailed example may use some portion of bits (such as two to four bits) that represent a mantissa or a base value for the floating point number, and some portion of bits (such as three to five bits) that represent an exponent applied to the mantissa to produce the floating point number. The FP8 number in some examples may further be signed, such as using a leading bit to indicate whether the floating point number is positive or negative in value.

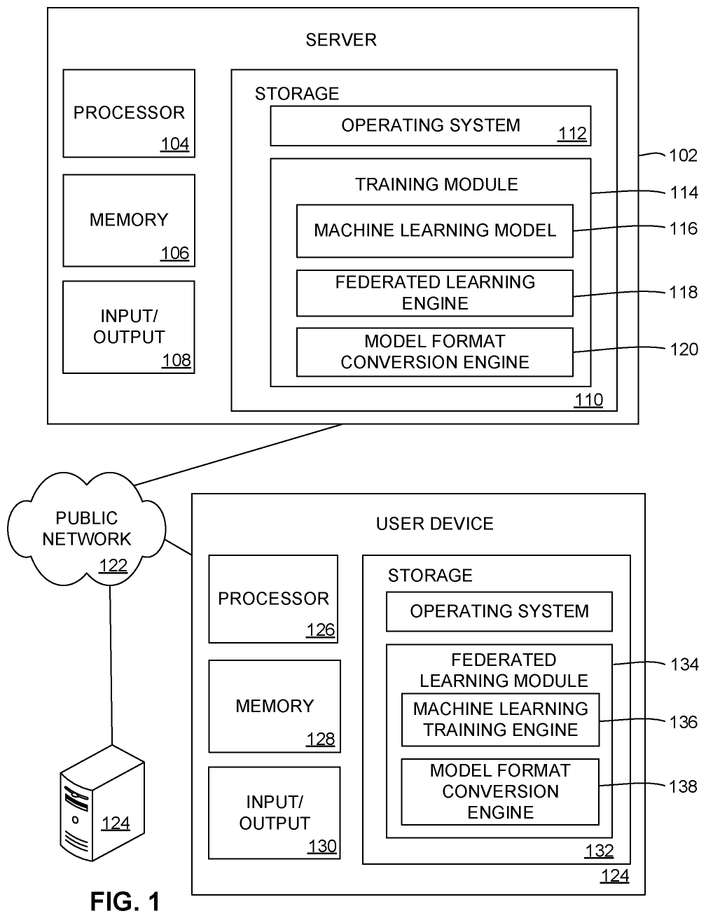

FIG. 1 is a block diagram of a computing environment that may be used to practice reduced-precision federated learning, consistent with an example embodiment. Here, the server 102 includes a processor 104 operable to execute computer program instructions and a memory 106 operable to store information such as program instructions and other data while computerized device 102 is operating. The server may exchange electronic data, receive input from a user, and perform other such input/output operations with input/output 108. Storage 110 may store program instructions including an operating system 112 that provides an interface between software or programs available for execution and the hardware of the server, and that may manage other functions such as access to input/output devices. The storage 110 may also store program instructions and other data for a training module 114, including machine learning model 116, a federated learning engine 118, and a model format conversion engine 120. In this example, the computerized device may also be coupled via a public network 122 to one or more user devices 124, such as remote client computers smartphones, or other such computerized user devices.

The user device 124 in this example also comprises a processor 126 that is operable to execute computer program instructions, a memory 128 that is operable to store information such as computer instructions and data being processed by executing programs, and input/output 130 such as a network connection to public network 122. Storage 132 stores program instructions and data such as an operating system and a federated learning module 134. The federated learning module includes a machine learning training engine 136 operable to train a machine learning model such as a neural network, and a model format conversion engine 138 operable to convert a machine learning model between different formats such as between a high-precision format and a reduced-precision format.

In operation, the server 102's training module may access a machine learning model 116, such as a voice recognition engine, next word predictor, a neural network, a generative pretrained transformer, or another such machine learning model that may learn to provide a desired output in response to an input through training such as through backpropagation of observed output errors using training data. The machine learning model may be distributed to a plurality of end user devices 124 via public network 122 for training on the end user devices in a federated learning process, after being converted from a high-precision format to a reduced-precision format via model format conversion engine 120.

The machine learning model is converted to a reduced-precision format in some examples to provide various benefits such as to reduce the amount of data communicated via public network 122 to each end user device 124, to reduce the amount of memory 128 that the machine learning model consumes on each end user device once downloaded from server 102, and to reduce the processing burden and battery consumption on end user devices in training the machine learning model.

The user device 124 may receive the machine learning model and may store it in storage 132, and in a further example may convert the reduced-precision machine learning model to a local copy of a high-precision machine learning model. In some such examples, training the machine learning model may be performed on the reduced-precision format model, which may subsequently be used to update the high-precision machine learning model. Conducting training using a reduced-precision model such as FP8 may consume less battery power, take less computational time, and consume less memory than training a high-precision model such as a model using FP32 coefficients for node weights and other tensors. In a more detailed example of training on a user device using a reduced-precision format, high-precision format weights such as FP32 master weights are converted to a reduced precision format such as FP8 using nearest neighbor rounding, and the converted FP8 model is used in an FP8 compute unit to perform training such as using backpropagation of output error and other such methods. The update FP8 tensor may then be used to update the FP32 master weights, which in some examples may be re-quantized to generate an update FP8 model based on the FP32 master weights.

In some examples, a scale factor may further be applied to the FP8 reduced-precision format machine learning model, such that a greater percentage of the range of values that may be covered by FP8 variables is employed to encode the converted FP32 high-precision weights. In a more detailed example, an FP8 reduced-precision machine learning model may be received from another device such as a remote server along with one or more weights that may be applied to the FP8 reduced-precision machine learning model to obtain an approximation of the original FP32 high-precision machine learning model weights. Weights may be similarly employed in the FP8 or reduced-precision end user device training process, and may further be used in using the modified or trained FP8 weights to update the FP32 high-precision master weights.

Once a plurality of end user devices 124 have received and trained reduced-precision machine learning models, the federated learning module in each device may send a trained reduced-precision model back to the server 102 for aggregation. In some examples, the reduced-precision model sent back to the server is derived from a FP32 master weight machine learning model maintained on the end user device, encoded with a stochastic quantizer operable to impart a random bias used to generate the FP8 weights from the high-precision FP32 master weights. When the server 102 receives the trained reduced-precision models (and in further examples model weights) from the end user devices, the FP8 models are de-quantized to produce high precision or FP32 weights that are then used to update the machine learning model. The updated machine learning model, having the benefit of recent training on a plurality of end user devices 124, may then be distributed back to end user devices such as by using a stochastic or randomized quantizer to generate a reduced precision or FP8 model from the server's updated FP32 machine learning model

These examples show how use of a reduced-precision machine learning model can reduce the amount of communication between a server such as that shown at 102 and various end user devices 124, and how processing or training a reduced-precision machine learning model on the end user device can conserve battery and consume less processing power on the user's device. Conversion using different quantization methods, such as using nearest-neighbor rounding to convert a high-precision copy of a machine learning model to a reduced-precision model on an end user device for training and using stochastic randomized rounding to convert a trained local high-precision model on a user device to a trained reduced-precision model sent back to the server or another aggregating device can improve performance when communicating or training using reduced-precision machine learning models

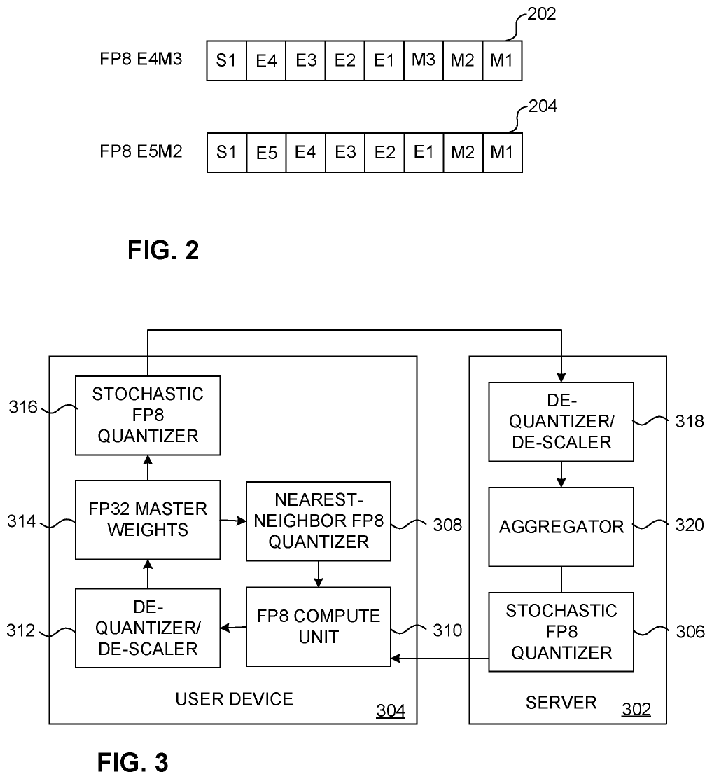

FIG. 2 is a diagram showing example reduced-precision number formats, consistent with an example embodiment. An 8-bit floating point number standard known as FP8 E4M3 is shown at 202, and comprises a leading sign bit (S1), four exponent bits (E4-E1), and three mantissa bits (M3-M1). The base number represented by mantissa bits M3-M1 is raised to the exponent E4-E1 to generate a floating point number with sign indicated by S1. The exponent bits in a further example may represent negative and positive exponents, such as using the 16 possible encodings available with the four exponent bits E4-E1 to encode a range of positive eight to negative eight for exponent values. In some further examples, this range may be reduced slightly to allow for special encodings, such as “Not a Number” or NaN, or other special coding values. The example FP8 coding shown at 204 comprises two mantissa bits M2-M1, five exponent bits E5-E1, and a sign bit S1, providing greater dynamic range than the E4M3 coding shown at 202 but with less precision within the range of possible values due to the smaller mantissa. Similar to the example shown at 202, the E5M2 coding shown at 204 may encode five bits worth of exponent data for a total of 32 possible values, which in further examples may comprise up to 16 negative and 16 positive values. In some examples, the range of exponents may again be reduced for coding special values, such as NaN or the like.

In both the E4M3 and E5M1 examples of FP8 encodings shown in FIG. 2, the range of numbers that can be encoded is increased by dedicating a select number of bits to an exponent value. In some further examples, different applications may benefit from having different precision or dynamic range, such as may be encoded using different numbers of exponent bits in an FP8 or similar number format. In one such example, a format such as E4M3 having fewer exponent bits may be used for model weights and activation functions, while a format such as E5M2 having a greater number of exponent bits may be used for model gradients. In other examples, other number formats, exponent bits, and the like may be preferred for similar reasons, and may be determined experimentally or mathematically.

FIG. 3 is a block diagram showing high-precision and reduced-precision machine learning models in a federated learning environment, consistent with an example embodiment. Here, a server 302 may distribute a machine learning model to one or more user devices 304, such as for federated learning or for training the machine learning model on the end user devices. The server 302 starts with a high-precision machine learning model that may be trained locally, may have been trained previously using federated learning, may be untrained, or may be provided through other means. The high-precision machine learning model may be converted to a reduced-precision model using a stochastic quantizer, such as a quantizer that uses a random number in determining rounding down from a high-precision format such as FP32 to a reduced-precision format such as FP8. The reduced-precision model may then be communicated to a plurality of end user devices 304, which receives the reduced-precision model and stores it for training in compute unit 310. The reduced-precision machine learning model in a further example also comprises a scale factor that may be used to scale the weights in the reduced-precision machine learning model.

The compute unit 310 in this example may be constructed to handle weights, tensors, and/or other data in a reduced-precision format such as FP8, reducing the computational burden and power consumption used in training the reduced-precision machine learning model. Upon training, the modified reduced-precision machine learning model may be de-quantized and scaling removed at 312, such as to generate a high-precision version of the machine learning model. This high-precision version of the machine-learning model is represented by the FP32 master weights shown at 314. This high-precision version of the machine learning model may then be used to update the reduced-precision model for another round of training such as using nearest-neighbor rounding FP8 quantizer 308. The FP8 compute unit in some examples may therefore work with a rounded and quantized version of the FP32 master weights shown at 314 rather than continue to process its own FP8 reduced-precision weights across rounds of training, such that the FP32 master weights shown at 314 effectively determine the weights being trained in repeated training rounds in the FP8 compute unit 310.

Once the training rounds are complete, the FP32 master weights shown at 314 are updated using the de-quantizer and scaler 312 to reflect the most recent FP8 training from compute unit 310. These updated FP32 master weights may be processed using a stochastic or randomized quantizer 316 to convert the high-precision FP32 master weights to reduced-precision FP8 weights (and in further embodiments a scale factor) for communication to server 302. The server 302 may receive the trained reduced-precision machine learning model, and de-quantize and de-scale trained reduced-precision machine learning models from a plurality of user devices 304 before aggregating them in aggregator 320. Aggregation in various examples may use various averaging methods, such as weighted averaging, geometric averaging, arithmetic averaging, or any other such method. The aggregated high-precision machine learning model becomes the new “master” machine learning model stored on the server 302, and may be converted to a reduced-precision model using stochastic or randomized FP8 quantizer 306 such that a model updated with the aggregated training results may be distributed to end user devices 304.

In a more detailed example, aggregation as performed in aggregator 320 comprises error minimization for both weights and for scale factors, such as minimizing mean squared error for both weights w and scale factors a. Minimizing both mean squared errors may be challenging in that the loss function for the scale factor a is not differentiation-friendly, and so the mean squared error may be performed in multiple steps in some examples. In a more detailed example, the scale factors or ranges are fixed and model weights are optimized for mean squared error using a method such as gradient descent, as reflected in expression [1] below, and then model weights are fixed and the best scale factors using mean squared error calculation are found using a grid search as reflected in the below expression [2]. Depending on the neural network model and data sets used to evaluate this method, improvement of 0.5% to 1% in model accuracy has been experimentally observed.

$${w}^{t + 1} , {α}^{t + 1} = arg {min}_{w , α} \frac{1}{P} {\sum }_{i ∈ {P}_{t}} {‖ {Q}_{R a n d} ( w ; α ) - {Q}_{R a n d} ( {w}_{i}^{t + 1} ; {α}_{i}^{t + 1 )} ‖}^{2} \qquad [ 1 ]$$

$${min}_{i} {α}_{i}^{t + 1} : \# grids : {max}_{i} {α}_{i}^{t + 1} \qquad [ 2 ]$$

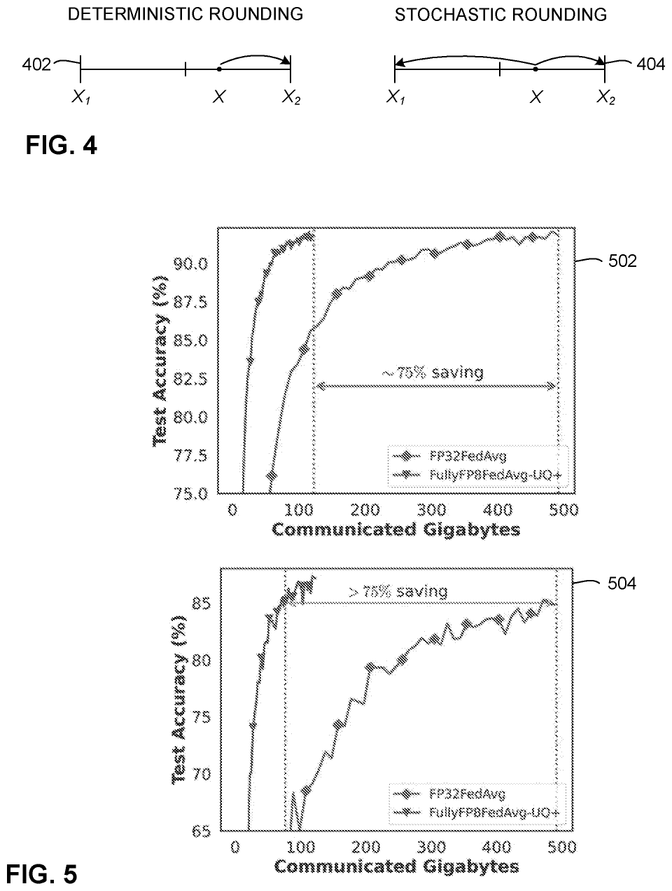

Conversion between reduced-precision and high-precision machine learning model formats in the example of FIG. 3 uses different methods for converting a trained machine learning model for communication (such as stochastic or random FP8 quantization at 306 and 316) and converting a high-precision machine learning model to a reduced-precision format for further training using nearest-neighbor rounding FP8 quantizer 308. FIG. 4 shows two methods of converting a number from one quantization format to another, consistent with an example embodiment. Converting between quantization formats, such as converting an FP32 high-precision number to an FP8 reduced-precision format, may often result in the original value X lying between two quantization levels in the new number format, shown in FIGS. 4 as X₁ and X₂. Different quantization methods may choose whether to map a value of X to X₁ or X₂ based on factors such as distance from X to X₁ and/or X₂, randomization, and other such factors in various embodiments.

In the deterministic rounding example shown at 402, the value in the original format denoted by an X is being mapped through a quantization process to either X₁ or X₂. Using deterministic rounding, the rounding process simply determines whether X is closer to X₁ or to X₂, and chooses the nearest one. If the value X is equidistant between X₁ and X₂, various tiebreaker methods may be employed such as rounding up or down, rounding to an odd number over an even number, randomly choosing between X₁ and X₂, and the like. This rounding example is called deterministic because the rounding result is dependent on the input value of X, and with the exception of using random selection when X is equidistant between X₁ and X₂, will produce the same output every time given the same inputs.

The stochastic rounding example shown at 404 differs from the deterministic rounding example of 402 in that a value X is being mapped through a quantization process to either X₁ or X₂ at least in part on a random number or a probability. In one such example, the probability of X being mapped to either X₁ or X₂ is dependent on the position of X between X₁ or X₂, such that the probability of being mapped to either X₁ or X₂ increases with how near X is to X₁ or X₂ respectively. In a more detailed example, the probability of X being mapped to X₁ may be determined using expression [3] as follows:

$$WEIGHT PROBABILITY = \frac{{X}_{2} - X}{{X}_{2} - {X}_{1}} \qquad [ 3 ]$$

Similarly, the probability of X being mapped to X₂ may be determined using expression [4] as follows:

$$WEIGHT PROBABILITY = \frac{X - {X}_{1}}{{X}_{2} - {X}_{1}} \qquad [ 4 ]$$

The probabilities calculated using expressions [3] and [4] may be applied using a random number generator, such that the generated random number is applied to the probability to determine whether X is rounded to X₁ or X₂. In practice, because the weight probabilities of expressions [3] and [4] are complimentary in that the probabilities always add up to one, only one or the other expressions need be calculated and applied to a random number to determine whether X is rounded to X₁ or X₂.

By using deterministic or nearest-neighbor quantization as shown at 402 in the quantizer 308 of FIG. 3, convergence of a machine learning model being trained may be improved. In contrast, stochastic or randomized quantization as shown at 404 may be employed in the quantizers 306 and 316 of FIG. 3, resulting in removal of quantization bias when collecting trained reduced-precision models for aggregation in an aggregating device such as a central server or when distributing reduced-precision machine learning models to user devices for training using federated learning methods.

Experimental results confirm that using nearest-neighbor quantization during training as reflected at 308 of FIG. 3 provides improved performance over using stochastic or randomized rounding, across multiple neural network model types and data sets, providing an accuracy improvement of between 0.1% and 1% depending on the model type and data set under test. Similarly, experimental results show that using unbiased stochastic or randomized rounding for communication as shown at 306 and 316 of FIG. 3 across different neural network model types and data sets provides a significant accuracy improvement over using deterministic or nearest-neighbor rounding, showing an improvement of between 0.5% and 6.8% depending on the data set and network model type being employed for the test. Careful selection of the appropriate rounding type for training vs. communication applications in quantizing or rounding between high-precision and reduced-precision machine learning models may therefore provide significant improvement in overall performance of the federated learning model.

FIG. 5 shows charts illustrating the reduction in for various levels of machine learning model accuracy, consistent with an example embodiment. At 502, the chart shows machine learning model accuracy (as Test Accuracy (%)) for independent and identically distributed data partitions vs. the number of gigabytes of data communicated to embed the machine learning model for both FP32 and FP8 models. As the chart reflects, similar accuracy can be obtained using an FP8 model but with a 75% reduction in communications capacity consumed relative to the same level of accuracy for an FP32 model.

The chart shown at 504 similarly shows machine learning model accuracy (as Test Accuracy (%)), but for non-independent and identically distributed data, such as where the training data employed varies by end user. Here, the number of gigabytes of data communicated to embed the machine learning model for both FP32 and FP8 models again reflects that similar accuracy can be obtained using an FP8 model as with an FP32 model, but with a 75% reduction in communications capacity consumed.

Because machine learning model sizes may be quite large and because wireless communication consumes significant power on end user devices such as smartphones, tablets, and the like, this reduction in communicated data when using a reduced-precision machine learning model can result in significant battery life improvement in end user devices. Further, because a server such as server 102 of FIG. 1 may distribute the machine learning model to hundreds, thousands, or more end user devices, the cumulative network bandwidth saved by using a reduced-precision machine learning model may be considerable.

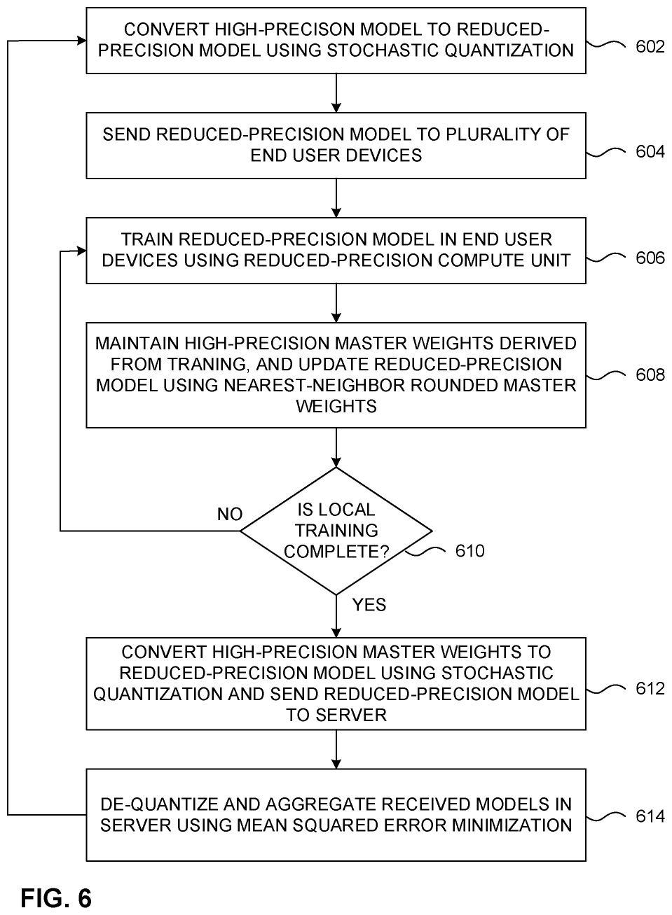

FIG. 6 is a flow diagram of a method of employing federated learning in end user devices using reduced-precision machine learning models, consistent with an example embodiment. At 602, a high-precision machine learning model may be provided as a new machine learning model, a machine learning model that has been previously trained on a server, a machine learning model that has previously undergone training via a federated learning process, or a machine-learning model obtained, created, and/or trained through other such means. The machine learning model may be converted to a reduced-precision machine learning model for communication to one or more end user devices, which in a further example comprises using a stochastic or randomized probability function to quantize the reduced-precision machine learning model weights based on the high-precision machine learning model weights. The reduced-precision machine learning model in some examples also includes a scale factor that may be used to scale the reduced-precision model weights to obtain an approximation of the high-precision machine learning model's weights.

The reduced-precision machine learning model generated at 602 may be sent to one or more end user devices at 604, such as to various end user devices in which the user has agreed to participate in federated learning-based training of the machine learning model, to end user devices employing the machine learning model in software on the end user device, or the like. Because the communicated machine learning model is in a reduced-precision format, the amount of data that is communicated to each participating end user device may be reduced significantly, such as by 75% in some examples.

The received reduced-precision model may be trained on the end user device using a reduced-precision compute unit at 606, such as using an FP8 compute unit operable to perform training using FP8 format weights and/or other tensors. As the weights are adjusted using training processes such as backpropagation of errors in outputs, a high-precision master weight model is maintained at 608, derived from the reduced-precision model. The master weights in a high-precision format may in a further example be used to update the reduced-precision model being trained, such as using nearest-neighbor rounding, so that the reduced-precision model being trained most closely reflects the high-precision weight values in the master weight model. This cycle of training and updating weights continues as reflected at 610 until training the local federated learning model is deemed complete, such as by completing processing a set of training data, by expiry of an amount of time, by manually ending training, or by another such trigger or measure.

Once training is complete, the high-precision master weights are converted at 612 to a reduced-precision model using stochastic or randomized quantization for communication back to the server or to another aggregating device. When the aggregating device receives the trained reduced-precision models from various end user devices, it aggregates the trained machine learning models by converting them to a high-precision format and applying a mean squared error minimization process to the received trained models. In a further example, error minimization may be performed for both weights and for scale factors, such as minimizing mean squared error for both weights w and scale factors a. This may be achieved by fixing scale factors and minimizing mean squared error for weights w, then fixing weights w and using a grid search to find the best scale factors based on a mean squared error calculation. The aggregated received model may then be distributed back to end user devices as a more trained or more refined machine learning model, and in some examples may be further trained or refined by repeating the federated learning process starting again at 602.

Some machine learning model training may include training a neural network, such as by applying backpropagation of output errors using training data to weights applied to activation functions linking nodes in a neural network. In some examples, a neural network may comprise a graph comprising nodes, such as may model neurons in a brain. In this context, a “neural network” means an architecture of a processing device defined and/or represented by a graph including nodes to represent neurons that process input signals to generate output signals, and edges connecting the nodes to represent input and/or output signal paths between and/or among neurons represented by the graph. In particular implementations, a neural network may comprise a biological neural network, made up of real biological neurons, or an artificial neural network, made up of artificial neurons, for solving artificial intelligence (AI) problems, for example. In an implementation, such an artificial neural network may be implemented by one or more computing devices such as computing devices including a central processing unit (CPU), graphics processing unit (GPU), digital signal processing (DSP) unit and/or neural processing unit (NPU), just to provide a few examples. In a particular implementation, neural network weights associated with edges to represent input and/or output paths may reflect gains to be applied and/or whether an associated connection between connected nodes is to be excitatory (e.g., weight with a positive value) or inhibitory connections (e.g., weight with negative value). In an example implementation, a neuron may apply a neural network weight to input signals, and sum weighted input signals to generate a linear combination.

In one example embodiment, edges in a neural network connecting nodes may model synapses capable of transmitting signals (e.g., represented by real number values) between neurons. Responsive to receipt of such a signal, a node/neural may perform some computation to generate an output signal (e.g., to be provided to another node in the neural network connected by an edge). Such an output signal may be based, at least in part, on one or more weights and/or numerical coefficients associated with the node and/or edges providing the output signal. For example, such a weight may increase or decrease a strength of an output signal. In a particular implementation, such weights and/or numerical coefficients may be adjusted and/or updated as a machine learning process progresses. In some implementations, transmission of an output signal from a node in a neural network may be inhibited if a strength of the output signal does not exceed a threshold value.

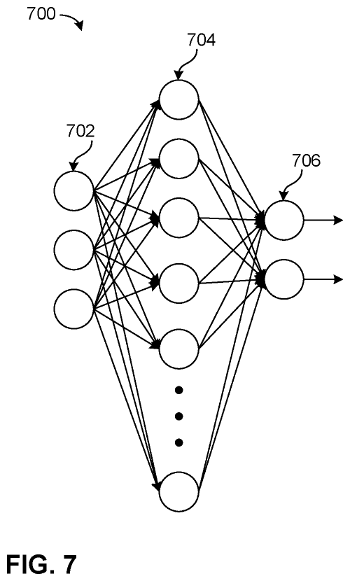

FIG. 7 is a schematic diagram of a neural network 700 formed in “layers” in which an initial layer is formed by nodes 702 and a final layer is formed by nodes 706. All or a portion of features of neural network 700 may be implemented various embodiments of systems described herein. Neural network 700 may include one or more intermediate layers, shown here by intermediate layer of nodes 704. Edges shown between nodes 702 and 704 illustrate signal flow from an initial layer to an intermediate layer. Likewise, edges shown between nodes 704 and 706 illustrate signal flow from an intermediate layer to a final layer. Although FIG. 7 shows each node in a layer connected with each node in a prior or subsequent layer to which the layer is connected, i.e., the nodes are fully connected, other neural networks will not be fully connected but will employ different node connection structures. While neural network 700 shows a single intermediate layer formed by nodes 704, other implementations of a neural network may include multiple intermediate layers formed between an initial layer and a final layer.

According to an embodiment, a node 702, 704 and/or 706 may process input signals (e.g., received on one or more incoming edges) to provide output signals (e.g., on one or more outgoing edges) according to an activation function. An “activation function” as referred to herein means a set of one or more operations associated with a node of a neural network to map one or more input signals to one or more output signals. In a particular implementation, such an activation function may be defined based, at least in part, on a weight associated with a node of a neural network. Operations of an activation function to map one or more input signals to one or more output signals may comprise, for example, identity, binary step, logistic (e.g., sigmoid and/or soft step), hyperbolic tangent, rectified linear unit, Gaussian error linear unit, Softplus, exponential linear unit, scaled exponential linear unit, leaky rectified linear unit, parametric rectified linear unit, sigmoid linear unit, Swish, Mish, Gaussian and/or growing cosine unit operations. It should be understood, however, that these are merely examples of operations that may be applied to map input signals of a node to output signals in an activation function, and claimed subject matter is not limited in this respect.

Additionally, an “activation input value” as referred to herein means a value provided as an input parameter and/or signal to an activation function defined and/or represented by a node in a neural network. Likewise, an “activation output value” as referred to herein means an output value provided by an activation function defined and/or represented by a node of a neural network. In a particular implementation, an activation output value may be computed and/or generated according to an activation function based on and/or responsive to one or more activation input values received at a node. In a particular implementation, an activation input value and/or activation output value may be structured, dimensioned and/or formatted as “tensors”. Thus, in this context, an “activation input tensor” as referred to herein means an expression of one or more activation input values according to a particular structure, dimension and/or format. Likewise in this context, an “activation output tensor” as referred to herein means an expression of one or more activation output values according to a particular structure, dimension and/or format.

In particular implementations, neural networks may enable improved results in a wide range of tasks, including image recognition, speech recognition, just to provide a couple of example applications. To enable performing such tasks, features of a neural network (e.g., nodes, edges, weights, layers of nodes and edges) may be structured and/or configured to form “filters” that may have a measurable/numerical state such as a value of an output signal. Such a filter may comprise nodes and/or edges arranged in “paths” and are to be responsive to sensor observations provided as input signals. In an implementation, a state and/or output signal of such a filter may indicate and/or infer detection of a presence or absence of a feature in an input signal.

In particular implementations, intelligent computing devices to perform functions supported by neural networks may comprise a wide variety of stationary and/or mobile devices, such as, for example, automobile sensors, biochip transponders, heart monitoring implants, Internet of things (IoT) devices, kitchen appliances, locks or like fastening devices, solar panel arrays, home gateways, smart gauges, robots, financial trading platforms, smart telephones, cellular telephones, security cameras, wearable devices, thermostats, Global Positioning System (GPS) transceivers, personal digital assistants (PDAs), virtual assistants, laptop computers, personal entertainment systems, tablet personal computers (PCs), PCs, personal audio or video devices, personal navigation devices, just to provide a few examples.

According to an embodiment, a neural network may be structured in layers such that a node in a particular neural network layer may receive output signals from one or more nodes in an upstream layer in the neural network, and provide an output signal to one or more nodes in a downstream layer in the neural network. One specific class of layered neural networks may comprise a convolutional neural network (CNN) or space invariant artificial neural networks (SIANN) that enable deep learning. Such CNNs and/or SIANNs may be based, at least in part, on a shared-weight architecture of a convolution kernels that shift over input features and provide translation equivariant responses. Such CNNs and/or SIANNs may be applied to image and/or video recognition, recommender systems, image classification, image segmentation, medical image analysis, natural language processing, brain-computer interfaces, financial time series, just to provide a few examples.

Another class of layered neural network may comprise a recurrent neural network (RNN) that is a class of neural networks in which connections between nodes form a directed cyclic graph along a temporal sequence. Such a temporal sequence may enable modeling of temporal dynamic behavior. In an implementation, an RNN may employ an internal state (e.g., memory) to process variable length sequences of inputs. This may be applied, for example, to tasks such as unsegmented, connected handwriting recognition or speech recognition, just to provide a few examples. In particular implementations, an RNN may emulate temporal behavior using finite impulse response (FIR) or infinite impulse response (IIR) structures. An RNN may include additional structures to control stored states of such FIR and IIR structures to be aged. Structures to control such stored states may include a network or graph that incorporates time delays and/or has feedback loops, such as in long short-term memory networks (LSTMs) and gated recurrent units.

According to an embodiment, output signals of one or more neural networks (e.g., taken individually or in combination) may at least in part, define a “predictor” to generate prediction values associated with some observable and/or measurable phenomenon and/or state. In an implementation, a neural network may be “trained” to provide a predictor that is capable of generating such prediction values based on input values (e.g., measurements and/or observations) optimized according to a loss function. For example, a training process may employ backpropagation techniques to iteratively update neural network weights to be associated with nodes and/or edges of a neural network based, at least in part on “training sets.” Such training sets may include training measurements and/or observations to be supplied as input values that are paired with “ground truth” observations or expected outputs. Based on a comparison of such ground truth observations and associated prediction values generated based on such input values in a training process, weights may be updated according to a loss function using backpropagation. The neural networks employed in various examples can be any known or future neural network architecture, including traditional feed-forward neural networks, convolutional neural networks, or other such networks.

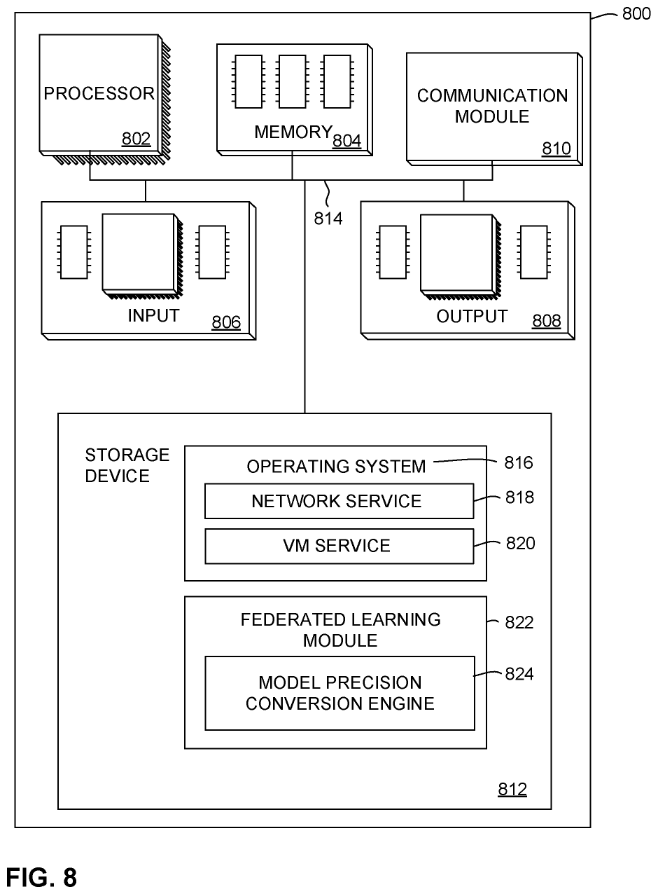

FIG. 8 shows a block diagram of a general-purpose computerized system, consistent with an example embodiment. FIG. 8 illustrates only one particular example of computing device 800, and other computing devices 800 may be used in other embodiments. Although computing device 800 is shown as a standalone computing device, computing device 800 may be any component or system that includes one or more processors or another suitable computing environment for executing software instructions in other examples, and need not include all of the elements shown here.

As shown in the specific example of FIG. 8, computing device 800 includes one or more processors 802, memory 804, one or more input devices 806, one or more output devices 808, one or more communication modules 810, and one or more storage devices 812.

Computing device 800, in one example, further includes an operating system 816 executable by computing device 800. The operating system includes in various examples services such as a network service 818 and a virtual machine service 820 such as a virtual server. One or more applications, such as image processor 822 are also stored on storage device 812, and are executable by computing device 800.

Each of components 802, 804, 806, 808, 810, and 812 may be interconnected (physically, communicatively, and/or operatively) for inter-component communications, such as via one or more communications channels 814. In some examples, communication channels 814 include a system bus, network connection, inter-processor communication network, or any other channel for communicating data. Applications such as federated learning module 822 and operating system 816 may also communicate information with one another as well as with other components in computing device 800.

Processors 802, in one example, are configured to implement functionality and/or process instructions for execution within computing device 800. For example, processors 802 may be capable of processing instructions stored in storage device 812 or memory 804. Examples of processors 802 include any one or more of a microprocessor, a controller, a central processing unit (CPU), a graphics processing unit (GPU), a neural processing unit (NPU), an image signal processor (ISP), a digital signal processor (DSP), an application specific integrated circuit (ASIC), a field-programmable gate array (FPGA), or similar discrete or integrated logic circuitry.

One or more storage devices 812 may be configured to store information within computing device 800 during operation. Storage device 812, in some examples, is known as a computer-readable storage medium. In some examples, storage device 812 comprises temporary memory, meaning that a primary purpose of storage device 812 is not long-term storage. Storage device 812 in some examples is a volatile memory, meaning that storage device 812 does not maintain stored contents when computing device 800 is turned off. In other examples, data is loaded from storage device 812 into memory 804 during operation. Examples of volatile memories include random access memories (RAM), dynamic random access memories (DRAM), static random access memories (SRAM), and other forms of volatile memories known in the art. In some examples, storage device 812 is used to store program instructions for execution by processors 802. Storage device 812 and memory 804, in various examples, are used by software or applications running on computing device 800 such as federated learning module 822 to temporarily store information during program execution.

Storage device 812, in some examples, includes one or more computer-readable storage media that may be configured to store larger amounts of information than volatile memory. Storage device 812 may further be configured for long-term storage of information. In some examples, storage devices 812 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 800, in some examples, also includes one or more communication modules 810. Computing device 800 in one example uses communication module 810 to communicate with external devices via one or more networks, such as one or more wireless networks. Communication module 810 may be a network interface card, such as an Ethernet card, an optical transceiver, a radio frequency transceiver, or any other type of device that can send and/or receive information. Other examples of such network interfaces include Bluetooth, 4G, LTE, or 5G, WiFi radios, and Near-Field Communications (NFC), and Universal Serial Bus (USB). In some examples, computing device 800 uses communication module 810 to wirelessly communicate with an external device such as via public network 122 of FIG. 1.

Computing device 800 also includes in one example one or more input devices 806. Input device 806, in some examples, is configured to receive input from a user through tactile, audio, or video input. Examples of input device 806 include a touchscreen display, a mouse, a keyboard, a voice responsive system, video camera, microphone or any other type of device for detecting input from a user.

One or more output devices 808 may also be included in computing device 800. Output device 808, in some examples, is configured to provide output to a user using tactile, audio, or video stimuli. Output device 808, in one example, includes a display, a sound card, a video graphics adapter card, or any other type of device for converting a signal into an appropriate form understandable to humans or machines. Additional examples of output device 808 include a speaker, a light-emitting diode (LED) display, a liquid crystal display (LCD or OLED), or any other type of device that can generate output to a user.

Computing device 800 may include operating system 816. Operating system 816, in some examples, controls the operation of components of computing device 800, and provides an interface from various applications such as federated learning module 822 to components of computing device 800. For example, operating system 816, in one example, facilitates the communication of various applications such as federated learning module 822 with processors 802, communication unit 810, storage device 812, input device 806, and output device 808. Applications such as federated learning module 1022 may include program instructions and/or data that are executable by computing device 800. As one example, federated learning module 822 may implement model precision conversion engine 824 to convert between high-precision and reduced-precision machine learning models such as in the examples described above. These and other program instructions or modules may include instructions that cause computing device 800 to perform one or more of the other operations and actions described in the examples presented herein.

Features of example computing devices such as those shown in FIGS. 1 and 8 may comprise features, for example, of a client computing device and/or a server computing device, in an embodiment. It is further noted that the term computing device, in general, whether employed as a client and/or as a server, or otherwise, refers at least to a processor and a memory connected by a communication bus. A “processor” and/or “processing circuit” for example, is understood to connote a specific structure such as a central processing unit (CPU), digital signal processor (DSP), graphics processing unit (GPU), image signal processor (ISP) and/or neural processing unit (NPU), or a combination thereof, of a computing device which may include a control unit and an execution unit. In an aspect, a processor and/or processing circuit may comprise a device that fetches, interprets and executes instructions to process input signals to provide output signals. As such, in the context of the present patent application at least, this is understood to refer to sufficient structure within the meaning of 35 USC § 112 (f) so that it is specifically intended that 35 USC § 112 (f) not be implicated by use of the term “computing device,” “processor,” “processing unit,” “processing circuit” and/or similar terms; however, if it is determined, for some reason not immediately apparent, that the foregoing understanding cannot stand and that 35 USC § 112 (f), therefore, necessarily is implicated by the use of the term “computing device” and/or similar terms, then, it is intended, pursuant to that statutory section, that corresponding structure, material and/or acts for performing one or more functions be understood and be interpreted to be described at least in FIG. 1 and in the text associated with the foregoing figure(s) of the present patent application.

The term electronic file and/or the term electronic document, as applied herein, refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

In the context of the present patent application, the terms “entry,” “electronic entry,” “document,” “electronic document,” “content,”, “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format).

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the term “parameters” (e.g., one or more parameters), “values” (e.g., one or more values), “symbols” (e.g., one or more symbols) “bits” (e.g., one or more bits), “elements” (e.g., one or more elements), “characters” (e.g., one or more characters), “numbers” (e.g., one or more numbers), “numerals” (e.g., one or more numerals) or “measurements” (e.g., one or more measurements) refer to material descriptive of a collection of signals, such as in one or more electronic documents and/or electronic files, and exist in the form of physical signals and/or physical states, such as memory states. For example, one or more parameters, values, symbols, bits, elements, characters, numbers, numerals or measurements, such as referring to one or more aspects of an electronic document and/or an electronic file comprising an image, may include, as examples, time of day at which an image was captured, latitude and longitude of an image capture device, such as a camera, for example, etc. In another example, one or more parameters, values, symbols, bits, elements, characters, numbers, numerals or measurements, relevant to digital content, such as digital content comprising a technical article, as an example, may include one or more authors, for example. Claimed subject matter is intended to embrace meaningful, descriptive parameters, values, symbols, bits, elements, characters, numbers, numerals or measurements in any format, so long as the one or more parameters, values, symbols, bits, elements, characters, numbers, numerals or measurements comprise physical signals and/or states, which may include, as parameter, value, symbol bits, elements, characters, numbers, numerals or measurements examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

1. A method comprising:
iteratively training a neural network model comprising one or more weights in a reduced-precision format to produce a high-precision format neural network model by:
training the neural network comprising one or more reduced-precision format weights in a reduced-precision format compute unit; and
updating the converted high-precision format neural network model based on the training;
converting the trained high-precision format neural network model to the reduced-precision format to produce a trained reduced-precision format neural network model; and
sending the trained reduced-precision format neural network model to an aggregating system.

2. The method of claim 1, further comprising:
receiving the neural network model comprising one or more weights received in a reduced-precision format from another device;
converting the received neural network model weights from the reduced-precision format to a high-precision format.

3. The method of claim 1, further comprising updating the reduced-precision format weights based on the updated converted high-precision format neural network model by rounding the converted high-precision format neural network weights to reduced-precision format weights using nearest neighbor rounding.

4. The method of claim 1, wherein converting the trained high-precision format neural network model to the reduced-precision format comprises rounding the trained high-precision format neural network weights to reduced-precision format weights using unbiased stochastic quantization.

5. The method of claim 1, wherein the received neural network model further comprises one or more scale factors.

6. The method of claim 1, wherein the reduced-precision format comprises an FP8 format comprising an exponent and a mantissa, and the high-precision format comprises an FP32 or single-precision floating-point format.

7. The method of claim 1, wherein the neural network comprises part of a large language model or a machine vision model.

8. The method of claim 1, wherein the method is performed on a plurality of federated learning devices, each operable to send results of training to the same aggregating system.

9. A method comprising:
receiving a plurality of trained neural network models from a respective plurality of remote devices in a reduced-precision format; and
aggregating the plurality of received trained neural network models to produce an aggregated trained neural network model in a high-precision format.

10. The method of claim 9, further comprising:
receiving a neural network model comprising one or more weights in a high-precision format;
converting the neural network model weights from the high-precision format to a reduced-precision format to produce a converted reduced-precision format neural network model; and
distributing the converted reduced-precision format neural network model to one or more remote devices for training using federated learning.

11. The method of claim 10, wherein converting the neural network model weights from the high-precision format to a reduced-precision format comprises using unbiased stochastic quantization.

12. The method of claim 9, further comprising distributing the aggregated trained neural network in a high-precision format to one or more remote devices using a reduced-precision format.

13. The method of claim 9, wherein aggregating the received trained neural network models comprises mean squared error minimization of weights of the received trained neural networks.

14. The method of claim 13, wherein aggregating the received trained neural network models further comprises mean squared error minimization of a scale factor.

15. The method of claim 14, wherein mean squared error minimization of a scale factor comprises performing a grid search of calculated errors using different scale factors.

16. The method of claim 9, wherein the reduced-precision format comprises an FP8 format comprising an exponent and a mantissa, and the high-precision format comprises an FP32 or single-precision floating-point format.

17. The method of claim 9, wherein the neural network comprises part of a large language model or a machine vision model.

18. A method, comprising:
transmitting a reduced-precision format of a neural network to one or more remote devices for training using federated learning over an electronic communication network;
receiving from the electronic communication network one or more trained neural networks from the one or more remote devices in a reduced-precision format; and
aggregating the received trained neural networks in a high-precision format to produce an aggregated trained neural network.

19. The method of claim 18, further comprising training the sent reduced-precision format neural network on the one or more remote devices using a reduced-precision compute module on at least one of the one or more remote devices.

20. The method of claim 19, further comprising storing weights in a high-precision format on the one or more remote devices during training.
